(19) United States
(12) Patent Application Publication
(10) Pub. No.: US 2013/0247683 A1
(43) Pub. Date: Sep. 26, 2013

(54) Device for measuring the surface energy of materials

(71) Applicants: Craig Andrew MacDougall, Corona, CA (US); Alan Eugene Scrivner, Corona, WA (US)

(72) Inventors: Craig Andrew MacDougall, Corona, CA (US); Alan Eugene Scrivner, Corona, WA (US)

(73) Assignee: The United States of America as represented by the Department of the Navy, Keyport, WA (US)

(21) Appl. No.: 12/661,837

(22) Filed: Mar. 24, 2010

Related U.S. Application Data
(60) Provisional application No. 61/211,200, filed on Mar. 26, 2009.

(51) Int. Cl. G01N 3/08

(52) U.S. Cl. CPC G01N 3/08
USPC 73/827

(57) ABSTRACT

The present invention is a device for measuring the surface energy of a material. The device includes a pulling mechanism and a clamp. A film, including an adhesive side, is attached to a surface to be measured. The film is clamped to surface energy measuring device. The device is placed flush on the surface. A pulling mechanism is pulled until a triangular piece of film tears and is removed from the surface. The device is then lifted off of the surface and a measurement is made at the pre-calibrated marking nearest the tip of the triangle torn into film.

### STATEMENT OF GOVERNMENT INTEREST

The invention described herein may be manufactured and used by or for the Government of the Untied States of America for governmental purposes without the payment of any royalties thereon or therefore.

### BACKGROUND

1. Field of the Invention

The present invention relates generally to a device to qualitatively measure the surface energy of a material to determine its suitability for the application of adhesive-backed labels.

2. Description of the Related Art

Measuring the surface energy of solids has proven to be difficult despite its wide application in manufacturing and production processes. Current methods for measuring surface energy are complex, require costly equipment, and often use toxic substances.

Materials like TEFLON have a low surface energy whereas materials like clean, polished copper have a high surface energy. Low surface energy materials require very sticky adhesives; conversely, high surface energy materials do not. Additionally, low-energy materials such as oils are spontaneously adsorbed by the high-energy surfaces, due to the reduction in the free surface energy of the system. This means that a clean, high-energy surface exposed to the normal ambient environment will not remain clean for long because the adsorption from the environment of water and organics will contaminate its surface. This is why a surface cleaning operation is typically included in many processes immediately before the actual application of the adhesive or adhesive containing materials.

Having the ability to determine the suitability of a particular label stock to adhere to a given material, based on surface energy, has implications in areas where labels are used. One such area is Item Unique Identification (IUID). Here, one often has to apply a label, with the proper adhesive, to a surface, with the expectation that a single label will survive the entire lifetime of an item. Knowing the surface energy of a base material will help measure the degree of surface contamination present, determine a suitable cleaning regimen, and determine whether or not an available label stock is compatible with the base surface material of the asset to be marked.

Liquids in contact with solid surfaces exhibit a contact angle between the surface and the wetting agent. Tensiometry is a collection of methods used to measure the contact angle and wettability of a surface.

Among the many tensiometric methods that have been developed over the years, contact angle goniometry, Wilhelmy balance tensiometry, and the use of dyne pens have become the most popular methods. In goniometry, a back-lit drop of liquid is optically imaged and the angle subtended by the drop at the point of solid-liquid contact is determined using machine vision algorithms. Wilhelmy balance tensiometry measures the wetting forces along the perimeter of a solid as it is immersed into a wetting agent. Dyne pens are chemical containing pens designed to apply a line of chemicals which will either wet the surface, if the surface energy is high enough, or form into beads if the surface energy is below a predetermined threshold.

Contact angle goniometry and Wilhelmy balance tensiometry are costly systems, requiring a laboratory setting for proper use and are thus unsuitable for field work.

The disadvantages of dyne pens is that these pens typically contain toxic chemicals, the chemicals they use have limited shelf-lives, and the interpretation of whether or not the line of chemicals has beaded up or has wet the surface is subjective. Additionally, to determine the surface energy of a range of surface types would require a collection of 15-30 dyne pens representing the spectrum of surface energies one would expect to encounter, making the use of dyne pens particularly expensive and time consuming. In addition, after being used on one surface, the tip of the pen should be considered contaminated, making subsequent measurements suspect.

Such previous methods must utilize special liquids and digital cameras to image and measure drop and liquid characteristics in the presence of a given substrate, and then apply the Young-Laplace equation to the measured characteristics in order to determine the surface energy. These methods are complex, require expensive equipment, often use toxic chemicals, and are ill suited for field measurements.

Thin adhesive films have become increasingly important in applications involving packaging, coating or for advertising. Once a film is adhered to a substrate, flaps can be detached by tearing and peeling, but they narrow and collapse in pointy shapes. Similar geometries are observed when peeling ultrathin films grown or deposited on a solid substrate, or skinning the natural protective cover of a ripe fruit. When detached flaps have perfect triangular shapes with a well-defined vertex angle, this is a signature of the conversion of bending energy into surface energy of fracture and adhesion. In particular, this triangular shape of the tear encodes the mechanical parameters related to these three forms of energy and could form the basis of a quantitative assay for the mechanical characterization of thin adhesive films, nanofilms deposited on substrates or fruit skin.

When trying to remove a rectangular strip from a roll of adhesive tape by scratching the edge with a device such as a fingernail, the strip often narrows, detaches and the final tear is often too short to be useful. Similar difficulties are experienced when trying to remove wallpaper, a sticker or a package label adhered to a solid surface. This behavior is shared by many other adhesive films that are of great importance in a number of industrial applications, such as packaging (wrappers and sealing tapes), light reflectors or polarizers in coatings and adhering stickers as panels and labels in advertising. In general, these films must be resilient to deformation when used as physical barriers in packaging, but at the same time readily tearable by hand. In addition, their adhesive strength depends on the substrate. They must be weak enough when in contact with certain surfaces to allow the films to be stored (as in a roll of tape), but strong enough when put in contact with the desired substrate. All of these properties are involved in determining the geometrical shapes observed when a film is ripped apart.

### SUMMARY OF THE INVENTION

To achieve the foregoing, and in accordance with the purposes of the present invention as embodied and broadly described herein, the present invention is a small handheld device for measuring the surface energy of materials by using a pre-calibrated adhesive film and a pulling mechanism. The film is applied to a surface, the pulling is pulled, and from the tear angle one can get an indication of the surface energy. The present invention uses fracture dynamics of a thin adhesive film applied to a surface as a means of measuring surface energy.

This invention provides a safe, inexpensive, convenient, and objective system for measuring the surface energy of materials in field applications. Another aspect of the present invention is the simplification of the interpretation of test results. Since the film used to test the surface is printable, marks may be printed upon the surface indicating “go/no-go” results tailored for a specific label type intended for use. The combination of providing simple operating procedures and simple interpretation of results minimizes any required training to use the system, providing the system with the advantage of wide-spread applicability. The present invention improves on known methods, such as contact angle goniometry and Wilhelmy balance tensiometry that require large complex and expensive equipment. The present invention is an improvement over dyne pens are chemical containing pens which use Amide/Glycol Ethers that are reproductive and kidney toxins, eye and skin irritants, and are combustible.

The present invention will allow technicians to choose labels and adhesives that will have the greatest chance of surviving intact for the life of the equipment.

### BRIEF DESCRIPTION OF THE DRAWINGS/FIGURES

The accompanying drawings and figures, which are incorporated in and form a part of this specification, illustrate embodiments of the invention and, together with the description, serve to explain the principles of the invention and to enable a person skilled in the relevant art to make and use the invention:

FIG. 1 is a side view of the device of the present invention.

FIG. 2 is a front view of the device of the present invention.

FIG. 3 is a rear view of the device the present invention.

FIG. 4 is a top view of a tab of the present invention.

FIG. 5 is a perspective view of a tab affixed to a substrate of the present invention.

### DETAILED DESCRIPTION OF THE PREFERRED EMBODIMENTS

The present invention will now be described with reference to the accompanying drawings. In the drawings, like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other devices and applications.

The device for measuring surface energy of materials is described with respect to FIGS.

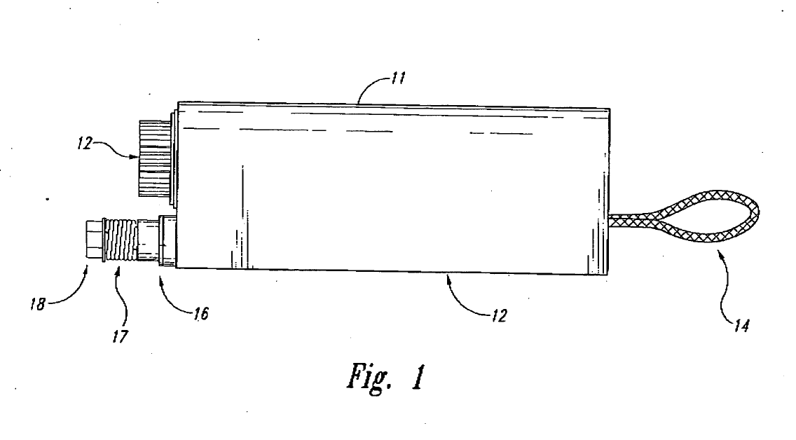

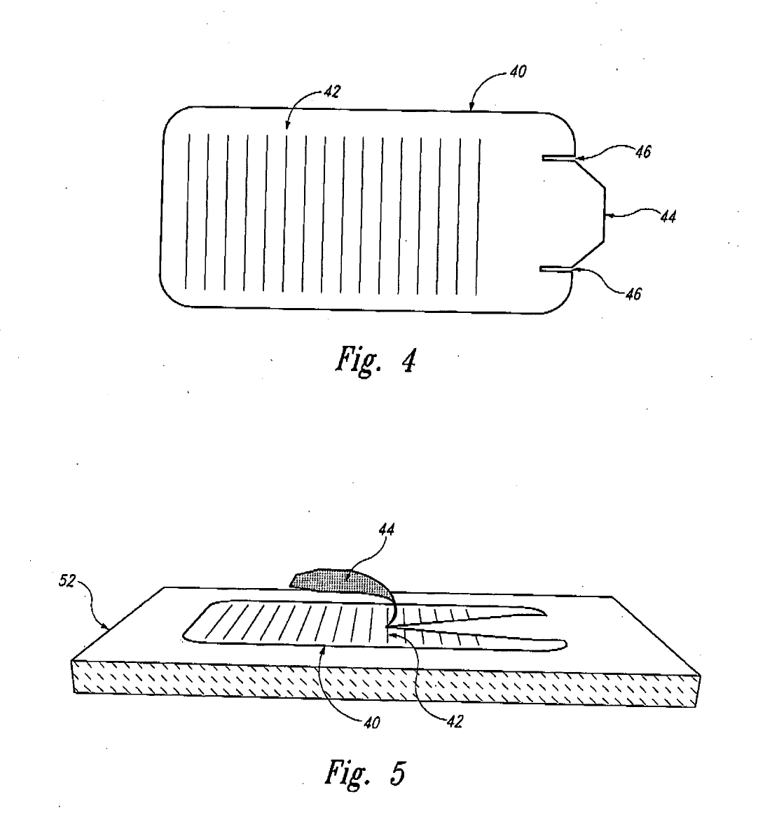

1-5. As shown in FIG. 1, the surface energy measuring device 10 of the present invention includes a rectangular box 11. In a preferred embodiment, box 11 is a rectangular wooden box, however, in alternate embodiments, other materials and shapes may be used as would be known to one skilled in the relevant art. Surface energy measuring device 10 further includes an internal dashpot 12 to limit the speed of the pull, a pulling mechanism 14 and a metal clamp 16 that attaches film 40, shown in FIG. 4, to surface energy measuring device 10. In a preferred embodiment, pulling mechanism 14 is a pull strap. The actuation velocity of dashpot 12 is controlled by adjusting a knob. Dashpot 12 regulates the speed at which the pull can be made.

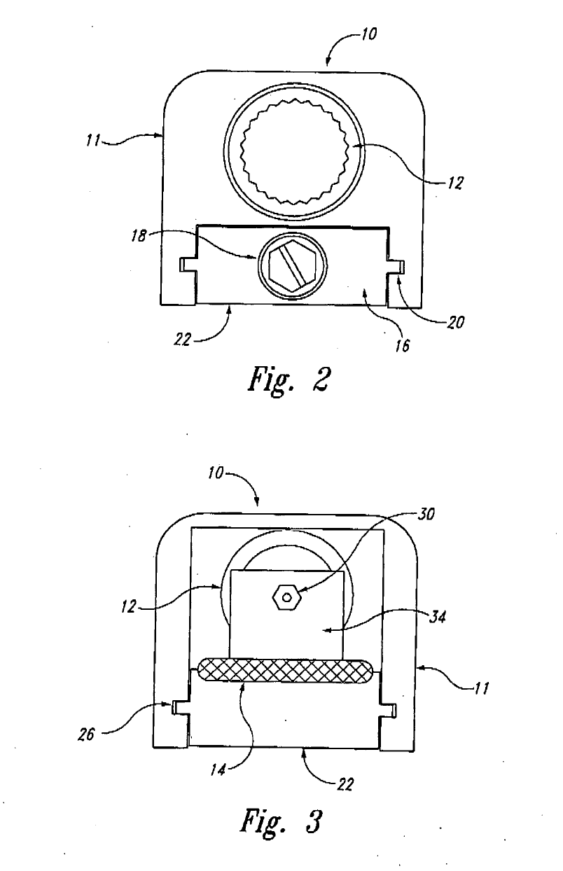

FIG. 2 shows the box 11 of the present invention including a tongue and groove joint 20 and a sliding platform 22. Dashpot 12 is connected to sliding platform 22 by a means of connection 24. In a preferred embodiment, means of connection 24 is an L-bracket. In a preferred embodiment, metal clamp 16 includes a compression spring 17 and an adjustment screw 16, as shown in FIG. 1. Clamp 16 is attached to a sliding platform 22 that slides the length of the dashpot draw by means of a tongue and groove joint 26. The bottom of sliding platform 22 is flush with the bottom of box 11.

FIG. 3 shows box 11 of the present invention including an L-bracket 34 attached to box 11 by a means of attachment 30. In a preferred embodiment, means of attachment is a retaining nut 30, wherein said retaining nut 30 attaches one of the ends of L-bracket 24 to dashpot 12 while the other end is screwed into sliding platform 22.

FIG. 4 shows a film 40, which in a preferred embodiment is a consumable graduated thin-film adhesive tape 40. Tape 40 includes pre-calibrated markings 42, a tab 44 and notches 46. Pre-calibrated markings 42 correspond to surface energy measurements for the material under study on one side and adhesive on the other side. Tape 40 is attached to surface energy measuring device 10 in the area created by tab 44 and notches 46 on both sides of tab 44. Notches 46 create fracture crack tips that will begin the propagation of a tear in film 40.

In a preferred embodiment of the present invention, film 40 is attached to a surface 52, as shown in FIG. 5. Film 40 is then bent up and folded over in the direction of the tear. The tear begins at the two notches 46 in film 40 and proceeds length-wise, forming a triangle that eventually detaches from the surface near one of the pre-calibrated markings 42. The end point of the triangular tear represents the measurement of the surface energy of the material.

To perform a surface energy measurement with the device of the present invention, film 40 is clamped to surface energy measuring device 10. Next, the backing material of film 40 is removed, and the adhesive side of film 40 is attached to a surface 52. Pull device 10 is placed flush on surface 52, and a slight downward pressure ensures a proper mating of the materials. Pull strap 14 is slowly pulled at a constant speed until a triangular piece of film 40 tears and is removed from surface 52, as shown in FIG. 5. Pull device 10 is then lifted off of surface 52 and a measurement is made at the pre-calibrated marking 42 nearest the tip of the triangle torn into film 40.

The surface energy can be computed using a simple equation presented in the article by Eugenio Hamm, Pedro Reis, Michael LeBlanc, Benoit Roman, and Enrique Cerda entitled Tearing as a test mechanical for characterization of thin adhesive films, Nat mater 7, no. 5 (May 2008): 386-390, which is herein incorporated by reference in its entirety.

In alternate embodiments, the pull device of the present invention could be actuated electro-mechanically or other mechanical methods for the application and removal of the thin adhesive film could be employed. Additionally, various printable designs on the surface of the test strips could be provided in alternate embodiments to expand utility and provide higher consistency and/or speed in the interpretation of results. Such alternate embodiments could include designs could provide instructions, utilize colors such as red/green, or could be tailored for specific geometries, such as curved surfaces.

Additionally, test strips could be engineered to test for flagging, which is an undesirable phenomenon where the corners or edges of a label lift from the surface due to the internal stress and strain of bending a flat label around a curve.

The present invention can be used in the surface preparation prior to painting. The present could further be used with Unique Item Identification (UII) where appropriate label materials must be determined and affixed to assets for the item's entire lifecycle. In both of these uses, the accuracy of the surface energy assessment of the present invention is critical to the successful completion of the tasks.

The present invention could further be applied to the field of training and quality control.

An objective measurement of the surface energy of manual process surface preparation steps could identify poor processes, contaminated cleaning supplies, contaminated equipment, or poor training. Identifying surface contamination could save time and money spent in subsequent steps which would have inevitably yielded a failure.

The present invention allows the surface energy to be easily measured and cataloged, which is particularly useful in the research and development stages of manufacturing where materials can be substituted, allowing for the optimization of material characteristics to overcome obstacles and increase profit. The present invention further facilitates distinguishing materials from one and another, particularly with plastics which can be easily confused with one and other. Knowledge of a specific plastic can be important due to the pervasiveness of plastics and their wide range in material characteristics, including melting points, resistances to solvents, and differing elastic and shear strengths.

While the invention has been particularly shown and described with reference to preferred embodiments thereof, it will be understood by those of ordinary skill in the art that various changes in form and details may be made therein without departing from the spirit and scope of the invention or any embodiment thereof. It will be apparent to a person skilled in the relevant art that this invention can also be employed in a variety of other devices and applications. All patents, patent applications and publications cited herein are fully incorporated by reference herein in their entirety.

What is claimed is:

1. A surface energy measuring device, comprising:
a box;
a pulling mechanism;
a dashpot, wherein said dashpot regulates pulling speed;
a sliding platform, wherein said sliding platform is connected to said dashpot by a means of connection; and
a clamp;
a tongue and groove joint, wherein said clamp is attached to said sliding platform by said tongue and groove joint;
a tape.

2. The device of claim 1, further comprising a knob, wherein said knob controls the velocity of said dashpot.

3. The device of claim 1, wherein said means of connection connecting said sliding platform and said dashpot is an L-bracket.

4. The device of claim 1, wherein said clamp further includes a compression spring and an adjustment screw.

5. The device of claim 1, wherein said tape is a consumable graduated thin-film adhesive.

6. The device of claim 1, wherein said tape further comprises a tab.

7. The device of claim 6, wherein said tape further comprises notches.

8. The device of claim 7, wherein said tape further comprises pre-calibrated markings, wherein said pre-calibrated markings correspond to surface energy measurements.

9. The device of claim 1, further comprising a retaining nut, wherein said retaining nut is attached to said L-bracket and said sliding platform.

10. The device of claim 1, wherein said box is rectangular shaped.

11. The device of claim 1, wherein said box is wooden.

12. A method for measuring the surface energy of a material, comprising the following steps:
providing a film that includes an adhesive side;
providing a surface energy device including a pulling mechanism;
clamping said film to said surface energy device;
removing an adhesive side of said film and attaching said adhesive side to a surface;
tearing said film by pulling said pulling mechanism; and
measuring the length of the tear on the adhesive.

13. The method of claim 12, wherein said tape further comprises a tab.

14. The method of claim 12, wherein said tape further comprises notches.

15. The method of claim 12, wherein said tape further comprises pre-calibrated markings, wherein said pre-calibrated markings correspond to surface energy measurements.

16. The method of claim 12, further comprising a retaining nut, wherein said retaining nut is attached to said L-bracket and said sliding platform.

17. The method of claim 12, wherein said device includes a retaining nut, wherein said retaining nut is attached to said L-bracket and said sliding platform.

18. The method of claim 12, wherein said device includes a dashpot, a sliding platform, and a clamp.

19. The device of claim 12, wherein said device includes a tongue and groove joint.

20. A method for measuring the surface energy of a material, comprising the following steps:
providing a film that includes an adhesive side;
providing a surface energy device including a pulling mechanism;
clamping said film to said surface energy device;
removing an adhesive side of said film and attaching said adhesive side to a surface;
tearing said film by pulling said pulling mechanism; and
measuring the length of the tear on the adhesive;
wherein said tape further comprises a tab, notches, and pre-calibrated markings, wherein said pre-calibrated markings correspond to surface energy measurements.
